(19) United States
(12) Patent Application Publication
(10) Pub. No.: US 2003/0129855 A1
(43) Pub. Date: Jul. 10, 2003

(54) Current collector assembly and method

(76) Inventor: Richard E. Douglas, Smyrna, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/328,249

(22) Filed: Dec. 23, 2002

Related U.S. Application Data
(60) Provisional application No. 60/342,349, filed on Dec. 21, 2001.

(51) Int. Cl. H01R 39/00

(52) U.S. Cl. 439/5; 439/13

(57) ABSTRACT

A current collector disc assembly and method preferably generally comprising a rotor segment, a rotor electrode, a stator segment, a stator electrode, a return channel, a current conduction block, a circulation control magnet, electrode supports, a passage, flow ports and a magnetically-polarized stabilizer insert.

### CROSS-REFERENCE TO RELATED APPLICATION

To the full extent permitted by law, the present application claims priority to and the benefit as a non-provisional application to provisional patent application entitled “Current Collector Assembly and Method” filed on Dec. 21, 2001, having assigned Serial No. 60/342,349, wherein said application is incorporated herein by reference.

### TECHNICAL FIELD

The present invention relates generally to motors and generators and, more specifically, to current collectors and methods related thereto. The present invention is preferably utilized in homopolar DC motors/generators; however, the present invention may also be utilized for other current transfer applications.

### BACKGROUND OF THE INVENTION

Electrical motors and generating systems are utilized in a multitude of applications, to produce mechanical power from an electric source or to produce electrical power from a mechanical source, respectively.

Unfortunately, in light of the present invention, prior-art devices are disadvantageous. More specifically, prior-art devices have historically utilized conductive brushes to collect current/transfer from the rotor to the stator or vice versa. Although suitable for some limited applications, brushes typically wear relatively quickly and thus deteriorate and fail, thereby resulting in premature failure and/or costly maintenance. Additionally, for high-speed applications, these problems are magnified. Moreover, when the device is utilized in a reverse-rotation direction from its normal use, such as a motor being utilized as a generator or vice versa, the brush contacts are known to more quickly wear and thus fail.

Because of the enormous utilization and reliance on electric motors and generators, even the slightest improvement can provide a substantial economic benefit. Moreover, because of the worldwide energy crises and universal demand for more efficient power sources, prior-art motors and generators have proved to be disadvantageous, causing many to search for alternative energy sources such as solar, hydro and electrochemical. Although many of these types of energy sources are inexpensive, they fail to serve as a sufficient or suitable alternative.

Consequently, it is readily apparent that there is a need for a current-collection assembly and method that is suitable for high-speed applications and can be utilized in either rotational direction without adversely affecting its efficiency or increasing its rate of wear and thus reducing a motor/generator's overall cost of maintenance. It is to such an improvement that the present invention is directed.

### BRIEF SUMMARY OF THE INVENTION

Briefly described, in a preferred embodiment, the present invention overcomes the above-mentioned disadvantages and meets the recognized need for such a device by providing a current-collection assembly and method.

According to its major aspects and broadly stated the present invention in its preferred form is a current collector disc assembly preferably generally comprising a rotor segment, a rotor electrode, a stator segment, a stator electrode, a return channel, a current conduction block, a circulation control magnet, electrode supports, a passage, flow ports and a magnetically-polarized stabilizer insert.

A feature and advantage of the present invention is to provide a current-collector assembly suitable for high-speed applications.

A feature and advantage of the present invention is to provide a current-collector assembly suitable for motor and generator applications, wherein said assembly can rotate in either direction without increasing wear or reducing efficiency.

A feature and advantage of the present invention is to provide a current-collector assembly and method having a relatively low cost for maintenance.

These and other objects, features and advantages of the invention will become more apparent to one skilled in the art from the following descriptions and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a partial sectional view along lines 2-2 of FIG. 3 of a current-collector assembly according to a preferred embodiment of the present invention.

FIG. 1A is an isometric view of a current-collector assembly according to a preferred embodiment of the present invention.

FIG. 1B is an isometric view of a current-collector assembly according to a preferred embodiment of the present invention.

FIG. 1C is an isometric view of a current-collector assembly according to a preferred embodiment of the present invention.

FIG. 1D is an isometric view of a current-collector assembly according to a preferred embodiment of the present invention.

FIG. 2 is a partial sectional view along lines 2-2 of FIG. 3 of a current-collector assembly according to an alternate embodiment of the present invention.

FIG. 3 is a sectional view of a current-collector assembly according to a preferred embodiment of the present invention.

FIG. 4 is a partial sectional view along lines 2-2 of FIG. 3 of a current-collector assembly according to an alternate embodiment of the present invention.

FIG. 5 is a partial sectional view along lines 2-2 of FIG. 3 of a current-collector assembly according to an alternate embodiment of the present invention.

FIG. 6 is a partial sectional view along lines 2-2 of FIG. 3 of a current-collector assembly according to an alternate embodiment of the present invention.

### DETAILED DESCRIPTION OF THE PREFERRED AND ALTERNATIVE EMBODIMENTS

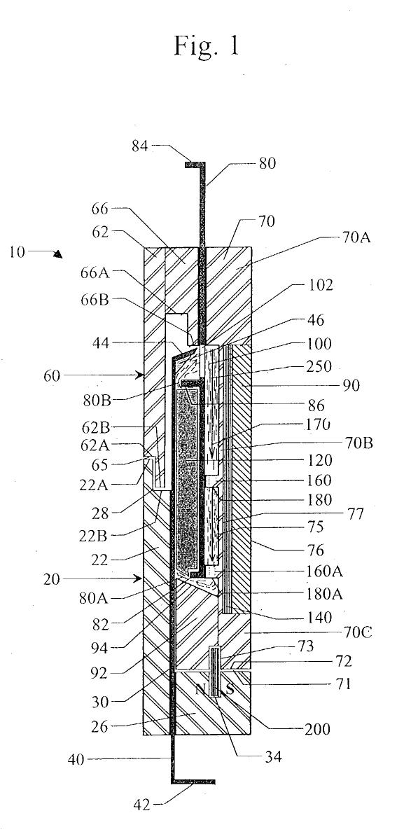

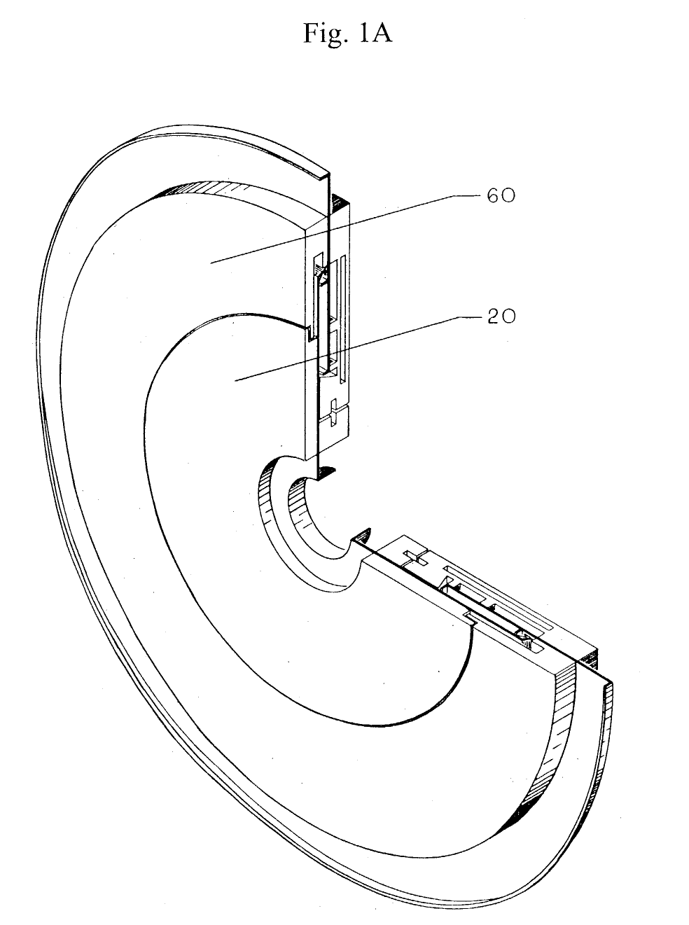

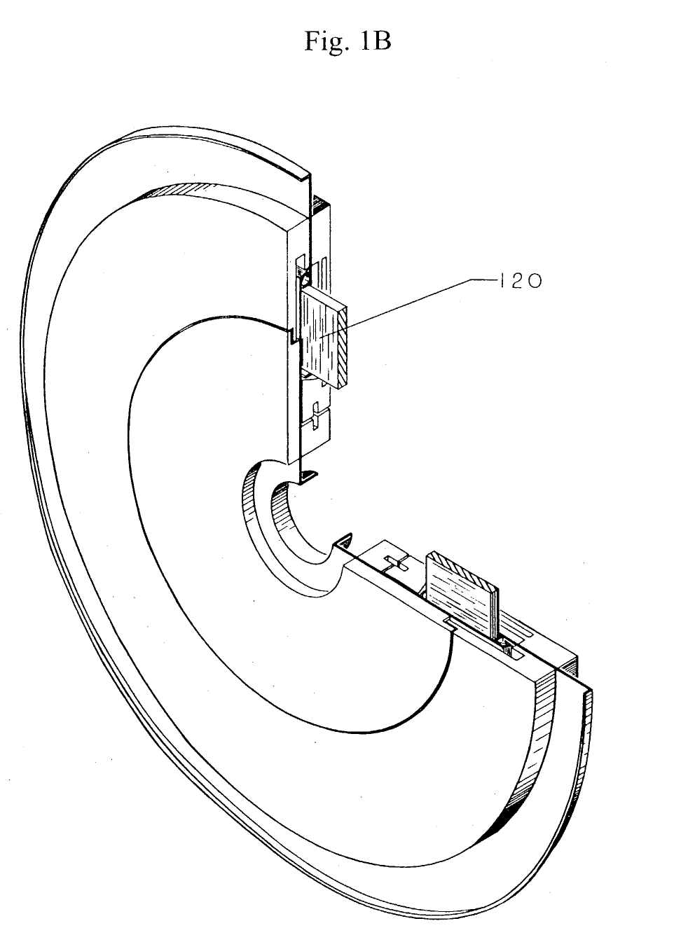

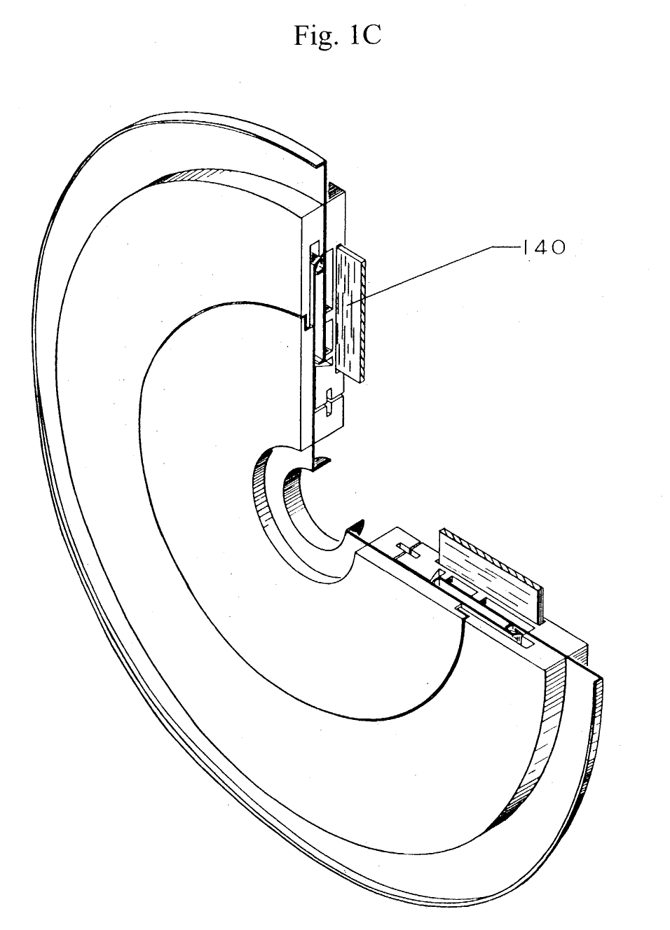

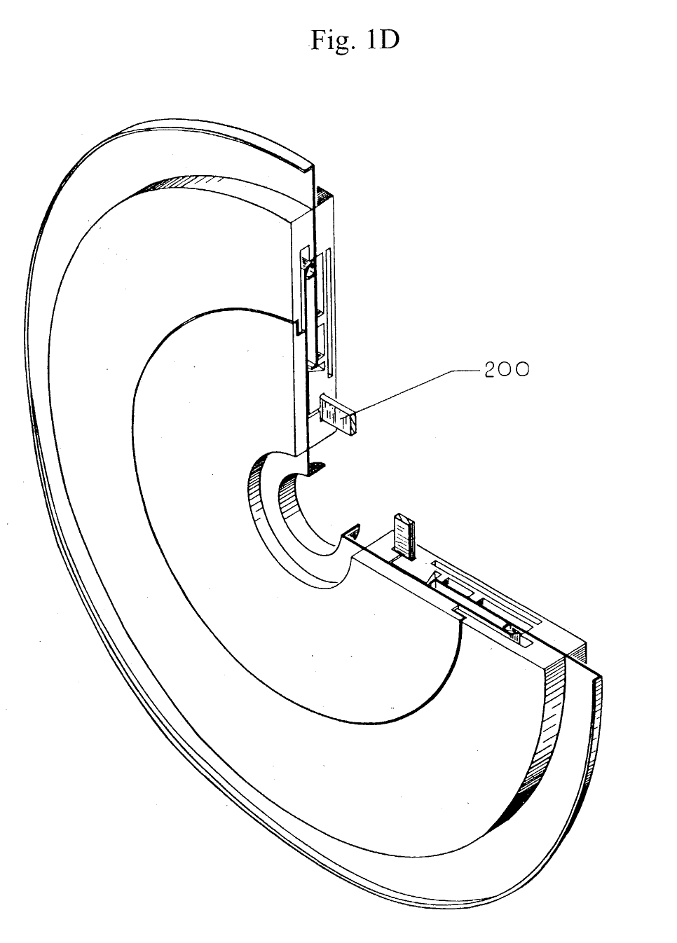

In describing the preferred and alternate embodiments of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar manner so as to accomplish similar functions.

Referring now to FIGS. 1, 1A, 1B, 1C and 1D, the present invention in its preferred embodiment is a device 10, wherein device 10 is a current collector disc assembly preferably generally comprising a rotor segment 20, a rotor electrode 40, a stator segment 60, a stator electrode 80, a return channel 100, a current conduction block 120, a circulation control magnet 140, electrode supports 160 and 160A, a passage 170, flow ports 180 and 180A and a magnetically-polarized stabilizer insert 200.

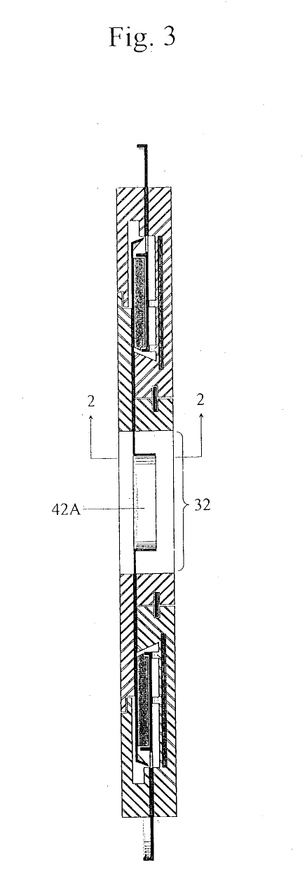

Specifically, rotor segment 20 is preferably substantially disk-shaped and ring-like in structure, preferably comprising a first disk 22, wherein first disk 22 preferably has first and second disk portions 22A and 22B, respectively, wherein the outer diameter of second disk portion 22B is smaller than the outer diameter of first disk portion 22A, thereby defining area 28. Rotor segment 20 further comprises a second disk 26 preferably positioned proximal to second disk portion 22B of first disk 22, wherein the outer diameter of second disk 26 is preferably smaller than the outer diameter of second disk portion 22B, thereby forming area 30, and wherein second disk portion 22B of first disk 22 and second disk 26 are preferably separated by rotor electrode 40. First disk 22 and second disk 26 preferably define a centrally positioned shared aperture 32, as best depicted in FIG. 3. Formed preferably around the outer circumference of second disk 26 is groove 34, wherein groove 34 is preferably axially positioned approximately the mid-region of second disk 26 and preferably extends partially through second disk 26. Groove 34 preferably functions to seat and secure a portion of stabilizer insert 200 therein. Rotor segment 20, in general, is preferably formed from an industrial ceramic such as, for exemplary purposes only, silicon nitride, and is preferably insulative and non-permeable to magnetic polarization.

Positioned preferably partially between second disk portion 22B of first disk 22 and second disk 26, and in communication with area 30, is rotor electrode 40, wherein rotor electrode 40 is preferably disk-shaped and ring-like in structure, and is preferably formed from a die stamped piece of beryllium copper. Although beryllium copper is the preferred conductive material for rotor electrode 40, it is contemplated in alternate embodiments that other suitable conductive materials could be used. Rotor electrode 40 further preferably has centrally formed therethrough aperture 42A (see FIG. 3), wherein a lip 42 preferably extends around the inner circumference of aperture 42A in a preferably perpendicular fashion from rotor electrode 40. Preferably formed around the outer circumference of rotor electrode 40 is lip 44, wherein lip 44 preferably extends slightly obtusely angled from rotor electrode 40. Lip 44 preferably cups a radial impeller 46, wherein radial impeller 46 is preferably a plurality of radial impeller blades that extend around the circumference of lip 44. In an alternate embodiment, radial impeller 46 could be a solid-disk-shaped piece of material having a plurality of scores or scallops formed thereon.

Stator segment 60 is preferably disk shaped and ring-like in structure. Specifically, stator segment 60 preferably comprises a third disk 62, wherein third disk 62 preferably has first and second disk portions 62A and 62B, respectively, wherein the diameter of the central opening of first disk portion 62A of third disk 62 is larger than the diameter of the central opening of second disk portion 62B of third disk 62, thereby defining area 65, wherein area 65 is proximal to area 28 of rotor segment 20. Furthermore, second disk portion 62B of third disk 62 is preferably in communication with a fourth disk 66, wherein fourth disk 66 preferably has first and second disk portions 66A and 66B, respectively, wherein the diameter of the central opening of first disk portion 66A of fourth disk 66 is larger than the diameter of the central opening of second disk portion 66B of fourth disk 66. Second disk portion 62B of third disk 62 is preferably in communication with first disk portion 66A of fourth disk 66. Preferably positioned proximal to second disk portion 66B of fourth disk 66 is fifth disk 70, wherein the diameter of the central opening of first portion 70A of fifth disk 70 is preferably equal to the diameter of the central opening of second disk portion 66B of fourth disk 66, and wherein second disk portion 66B of fourth disk 66 and fifth disk 70 are preferably separated by stator electrode 80.

Fifth disk 70 preferably comprises a first portion 70A, a second portion 70B and a third portion 70C, wherein second portion 70B preferably extends between first portion 70A and third portion 70C, and wherein second portion 70B is preferably thinner than first portion 70A and third portion 70C.

Groove 34 is defined by a sixth disk 92, third portion 70C of fifth disk 70 and second disk 26, wherein sixth disk 92 is preferably proximal to second disk 26 of rotor segment 20 and adjacent third portion 70C of fifth disk 70. Furthermore, the diameter of the central opening of sixth disk 92 is preferably approximately equal to the diameter of the central opening of fifth disk 70. Groove 34 preferably functions so as to seat and secure the remaining portion of stabilizer insert 200 therein. Furthermore, an outer circumferential wall 94 of sixth disk 92 is preferably of an angle so as to guide the flow of liquid metal 250. Second portion 70B of fifth disk 70 preferably comprises an inner surface 75 and an outer surface 77, wherein inner surface 75 carries a preferably centrally positioned electrode support 160 and further carries electrode support 160A preferably positioned proximal to outer wall 94 of fifth disk 92. Electrode supports 160 and 160A are preferably raised portions of second portion 70B that extend around the circumferential distance of second portion 70B and preferably function to support and maintain planar rigidity of stator electrode 80. Stator segment 60, in general, is preferably formed from an industrial ceramic such as, for exemplary purposes only, silicon nitride, and is preferably insulative and non-permeable to magnetic polarization.

Positioned preferably partially between second disk portion 66B of fourth disk 66 and first portion 70A of fifth disk 70 is stator electrode 80, wherein stator electrode 80 is preferably disk shaped and ring-like in structure, and is preferably formed from a die-stamped piece of beryllium copper. Although beryllium copper is the preferred conductive material for stator electrode 80, it is contemplated in alternate embodiments that other suitable conductive materials could be used.

Stator electrode 80 further preferably has a lip 82 preferably extending around the inner circumference thereof thereby forming flow gap 80A between stator electrode 80 and rotor electrode 40. Preferably formed around the outer circumference of stator electrode 80 is lip 84, wherein lip 84 preferably extends from stator electrode 80. Formed preferably centrally around stator electrode 80 is a raised portion 86, wherein a flow gap 80B, defined by raised portion 86 and lip 84, partially surrounds and retains current-conductor block 120, and wherein current-conductor block 120 is further surrounded and retained by rotor electrode 40.

Formed preferably around stator electrode 80, proximal to the base of raised portion 86, is return channel 100, wherein return channel 100 is a plurality of circumferentially spaced ports 102 formed through stator electrode 80. Ports 102 can be a predetermined series of circumferentially aligned ports positioned around the circumferential distance of stator electrode 80 or alternately, can be a series of aligned ports that graduate in number around the circumferential distance of stator electrode 80 such that the distance separating the ports can vary. Stator electrode 80 is preferably positioned between second disk portion 66B of fourth disk 66 and first portion 70A of fifth disk 70 such that lip 44 of rotor electrode 40 is preferably positioned to hover over return channel 100 in order to direct return flow of liquid metal 250 therethrough.

Top surface 75 of second portion 70B of fifth disk 70 and stator electrode 80 preferably form passage 170, wherein passage 170 preferably functions as a return-flow gallery and circulatory passage for liquid metal 250 therethrough. Specifically, through rotational movement of rotor segment 20 and thus rotor electrode 40, radial impeller 46 impels liquid metal 250 through passage 170, wherein liquid metal 250 passes through flow ports 180 and 180A formed in electrode supports 160 and 160A, respectively. Thereafter, liquid metal 250 flows through flow gap 80A and over and through current conduction block 120 and into flow gap 80B, thus completely covering current conduction block 120. Movement of rotor electrode 40 and thus radial impeller 46 continues to circulate liquid metal 250 over and through current conduction block 120 and out over raised portion 86, whereupon liquid metal 250 is pushed through return ports 102 of channel 100 and is once again returned to passage 170, thus allowing liquid metal 250 to be recirculated once again. Moreover, the angle of outer wall 94 of sixth disk 92 preferably assists in directing and confining liquid metal 250 to its particular circulatory pathway.

Preferably, held within the confines defined by first portion 70A, second portion 70B, third portion 70C and seventh disk 90 is circulation control magnet 140, wherein circulation control magnet 140 preferably extends around the circumference of second portion 70B of fifth disk 70. Circulation control magnet 140 preferably functions as a biasing magnet to contain and influence flow of the liquid metal 250 along its particular circular pathway.

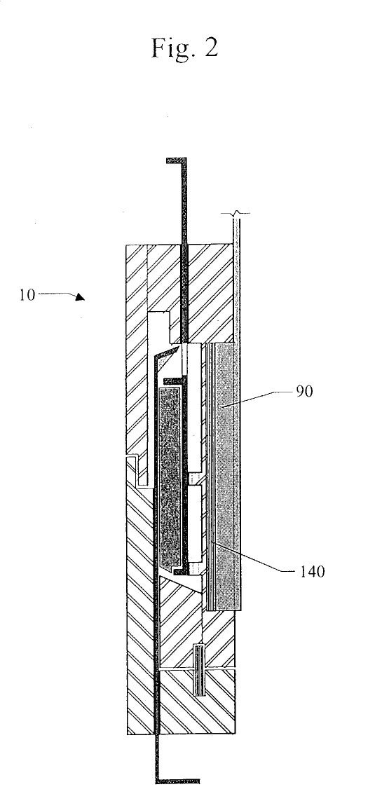

Preferably, seventh disk 90 is a thermally conductive structural insert positioned so as to confine and provide access to circulation control magnet 140 and to structurally enhance fifth disk 70. Seventh disk 90 preferably serves as a heat sink to absorb and redirect any heat generated within device 10. In an alternate embodiment (FIG. 2), an additional heat sink path to the exterior of device 10 may be in thermal communication with disk 70 to assist in the removal of thermal energy therein.

Current conduction block 120 is preferably a disk-shaped, floating piece of conductive material, wherein any suitable conductive material such as, for exemplary purposes only, sintered copper, can be utilized, and wherein floatation of current conduction block 120 is accomplished through liquid metal 250 flowing and circulating around it during rotational movement of device 10. The porous nature of sintered-copper block such as current conduction block 120 preferably promotes interstitial infiltration by the liquid metal and maintenance of an equalized bearing/conductive film at both major current-conduction-block surfaces.

Stabilizer insert 200 seated within groove 34 of second disk 26, fifth disk 70 and sixth disk 92 is preferably a polarized, floating, lateral-stabilizer insert 200, wherein stabilizer insert 200 preferably functions so as to maintain close tolerance and lateral alignment of rotor segment 20 and stator segment 60. Stabilizer insert 200 is preferably axially polarized in order to control assembly movement and positioning of liquid metal 250. More specifically, stabilizer insert 200 serves to ensure the confinement of liquid metal 250 within its circulatory pathway.

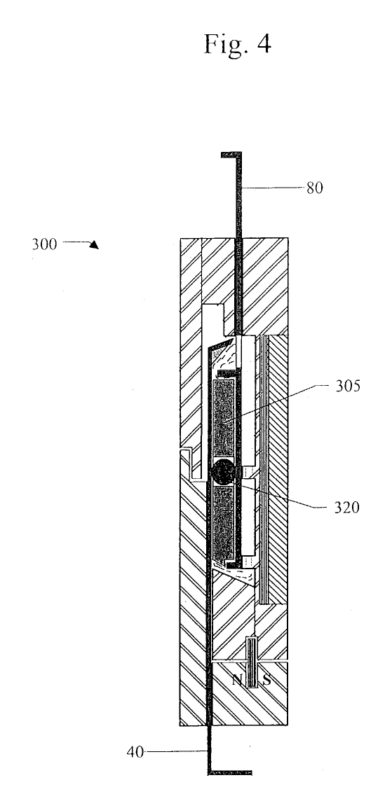

In an alternate embodiment 300, as shown in FIG. 4, preferably a ball bearing 320, a plurality of spaced apart ball bearings or a bearing ring is positioned preferably approximately centered with current-collection block 305, wherein ball bearing 320 serves as a rotational bearing surface between rotor electrodes 40 and 80, and current collection block 305. As in the preferred embodiment, a conductive fluid flows within the prescribed assembly.

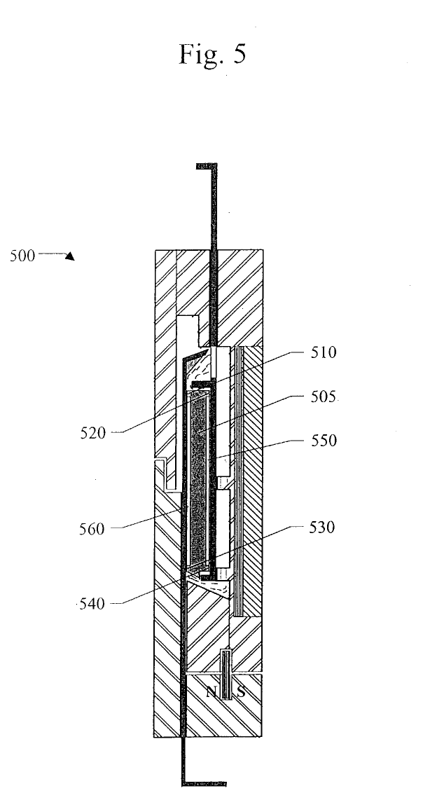

In an additional alternate embodiment 500, as shown in FIG. 5, a shouldered current-collection block 505 is utilized, wherein shouldered current-collection block 505 has first shoulder 510, second shoulder 520, third shoulder 530 and fourth shoulder 540. Shoulders 510, 520, 530 and 540 serve as bearing surfaces and thus reduce the overall hard surface contact and thus frictional losses. As in the preferred embodiment, a conductive fluid flows within gaps 550 and 560.

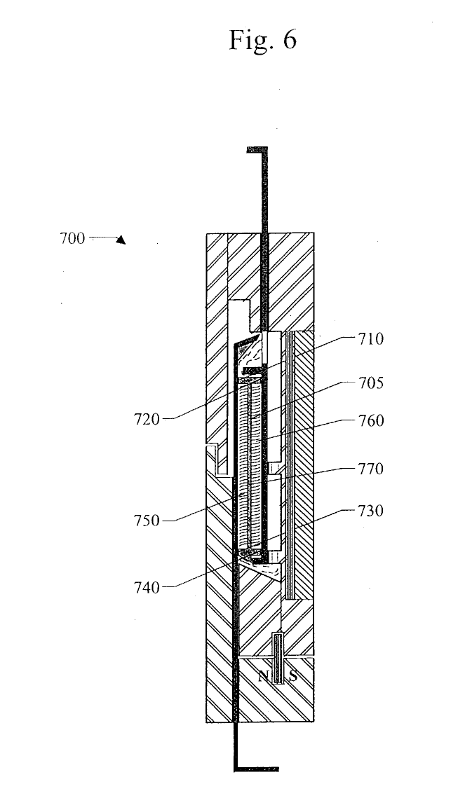

In an additional alternate embodiment 700, as shown in FIG. 6, a shouldered current-collection block 705, having a plurality of metallic brushes 750 and 760 positioned along the body 770, is utilized in place of the current-collection block 120 of the preferred embodiment. The metallic brushes 750, 760 serve as a flexible conductive contact medium for transferring current between rotor electrode 40 and stator electrode 80. To reduce wear on the brushes 750, 760 and to increase surface contact in both rotational directions, brushes 750 are slightly angled backwards such that when rotor electrode 40 is rotated in the clockwise direction, as viewed from the right side, brushes 750 make continuous and stress-reduced contact with rotor electrode 40. On the other hand, brushes 760 are slightly angled forwards such that when rotor electrode 40 is rotated in the counterclockwise direction, as viewed from the right side, brushes 760 make continuous and stress-reduced contact with stator electrode 80. As in the preferred embodiment, a conductive fluid flows within the prescribed assembly.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A current collector assembly, comprising:
a rotor segment;
a stator segment;
means for transferring current between said rotor segment and said stator segment, wherein said current transfer means is positioned proximal to said rotor segment and said stator segment; and
a conductive fluid in contact with said rotor segment, said stator segment and said current transfer means.

2. A method of current collection, comprising the step of:
a. positioning a means for transferring current between a rotor segment and a stator segment, wherein a conductive fluid is in contact with said rotor segment, said stator segment and said current transfer means to allow current to flow therebetween.
